(19) United States
(12) Patent Application Publication
(10) Pub. No.: US 2015/0352892 A1
(43) Pub. Date: Dec. 10, 2015

(54) FOLDABLE ORNAMENTAL ARTICLES

(71) Applicant: Arik NEMZER, Hod Hasharon (IL)

(72) Inventor: Arik NEMZER, Hod Hasharon (IL)

(21) Appl. No.: 14/758,128

(22) PCT Filed: Dec. 2, 2013
(86) PCT No.: PCT/IL13/50989

§ 371 Date: Jun. 26, 2015

(30) Foreign Application Priority Data
Dec. 12, 2012 (IL) 223610

(51) Int. Cl. B44C 3/00

(52) U.S. Cl. CPC B44C 3/00

(57) ABSTRACT

An ornamental including a main body, at least one folding-element, having a pivoting-side and a tip disposed oppositely to the pivoting-side, and a folding mechanism. The folding mechanism facilitates the user to pivot the at least one folding-element with respect to the main body and thereby, change the peripheral shape of the ornamental article. When all of the folding-elements are unfolded, the ornamental article is in an open state. When all of the folding-elements are folded, the ornamental article is in a closed state. Preferably, the ornamental article further includes holding mechanisms, such as magnets, for maintaining each one of the triangular folding-elements in either an open state position or a closed state position. Optionally, a holding mechanism is a pair of magnets having opposing polarity, such that the magnetic force attracts the magnets to each other.

### FIELD OF THE INVENTION

The present invention relates to the field of jewelry and more particularly, the present invention relates to an ornamental article such as a pendant, wherein the ornamental article includes a mechanism used to change the peripheral shape of the ornamental article.

### BACKGROUND OF THE INVENTION

Ornamental articles, such as jewelry, are typically made of a rigid piece, having a fixed shape.

However, it is often desired to change the peripheral shape of the adornment, for various reasons.

Some prior art foldable ornamental articles, with various limitations, have been introduced in the past. Great Britain patent GB 153459, by, J. M. Cutler, provides a badge, adapted to be used also as a pendant or ornament. The badge comprises a five-pointed star, the points 2 of which are hinged to a pentagonal center-piece so as to be foldable to form a polyhedral figure. A spring plate facilitates to hold the hinged parts open or closed up.

US patent application 2009/10293542, by James Anderson, provides a folding locket which can take the form of an oblong or cylindrical locket, and can be folded into a generally heart shaped locket. In either of these configurations, oblong or heart, the locket can be opened by rotating the two halves of the locket apart. When the two halves of the locket are rotated apart, a picture, hidden on each side of the locket becomes visible; thus, opening the locket makes visible two pictures which can be selected by the user. The pictures displayed in the mounting are mounted in the position which spans the fold line of the locket.

There is therefore a need and it would be advantageous to have an ornamental device that includes a mechanism facilitating to user to easily change the peripheral shape design of the ornamental article, in a variety of combination, as desired.

### SUMMARY OF THE INVENTION

According to the teachings of the present invention, there is provided an ornamental including a main body, having a front face and a rear face and a number of sides; at least one folding-element, having a front face, a rear face, a pivoting-side and a tip disposed oppositely to the pivoting-side; and a folding mechanism. The folding mechanism facilitates the user to pivot the at least one folding-element with respect to the main body and thereby, change the peripheral shape of the ornamental article, as viewed from a distance.

When all of the folding-elements are unfolded, the ornamental article is in an open state. When all of the folding-elements are folded, the ornamental article is in a closed state. When a portion of the folding-elements are folded, the ornamental article is in a semi-open state.

Preferably, the ornamental article further includes holding mechanisms for maintaining each one of the triangular folding-elements in either an open state position or a closed state position. Optionally, a holding mechanism is a pair of magnets having opposing polarity, such that the magnetic force attracts the magnets to each other.

Optionally, each of the sides of the main body, having a respective one of folding-elements pivotally attached thereto, and the pivoting-side of the respective folding-element, have one of the pair of magnets embedded therein, forming one of the holding mechanisms, wherein when the folding-element is in the open state, the folding-element is held adjacent to the respective side of the main body.

Optionally, one of the pair of magnets is embedded at a preconfigured location at the rear face of the main body, and a second of the pair of magnets is embedded at the tip of each of the folding-elements, wherein when the folding-element is in the closed state, the tip is held adjacent to the magnet embedded in the rear face of the main body.

Optionally, two or more of the magnets embedded at the preconfigured location at the rear face of the main body, up to the number of the folding-elements, are combined to form a single magnet.

Optionally, the main body has a regular hexagon shape and the folding-elements are six fitted triangular elements, pivotally attached to each of the six sides of the main body.

Optionally, the main body has a regular pentagonal shape and the folding-elements are five fitted triangular elements, pivotally attached to each of the five sides of the main body.

Optionally, the main body has a regular square shape and the folding-elements are four fitted triangular elements, pivotally attached to each of the four sides of the main body.

Optionally, the tips of the folding-elements are rounded.

### BRIEF DESCRIPTION OF THE DRAWINGS

The present invention will become fully understood from the detailed description given herein below and the accompanying drawings, which are given by way of illustration and example only, and thus not limiting in any way, wherein:

FIG. 1 is a front-perspective view illustration of a foldable ornamental device, facilitating to user to change the peripheral shape of the ornamental article, according to embodiments of the present invention, the article being in an open state.

FIG. 2 is a front view illustration of the foldable ornamental device shown in FIG. 1.

FIG. 3 is a rear view illustration of the foldable ornamental device shown in FIG. 1.

FIG. 4 is a side view illustration of the foldable ornamental device shown in FIG. 1.

FIG. 5 is a top view illustration of the foldable ornamental device shown in FIG. 1.

FIG. 6 is a perspective view illustration of the foldable ornamental device shown in FIG. 1, the article being in a folded state.

FIG. 7 is a front view illustration of the foldable ornamental device as shown in FIG. 6.

FIG. 8 is a rear view illustration of the foldable ornamental device as shown in FIG. 6.

FIG. 9 is a front view illustration of the foldable ornamental device shown in FIG. 1, the article being in an intermediate state, between the open state and the folded state.

FIG. 10 is a front-perspective view illustration of the foldable ornamental device as shown in FIG. 9.

FIG. 11 is a rear-perspective view illustration of the foldable ornamental device as shown in FIG. 9.

FIG. 12 is a front view illustration of the foldable ornamental device shown in FIG. 1, exemplify a rhombus design.

FIG. 13 is a front view illustration of the foldable ornamental device shown in FIG. 1, exemplify a triangle design.

FIG. 14 is a front view illustration of a foldable ornamental device, facilitating to user to change the peripheral shape of the ornamental article, according to an embodiment of the present invention, the article being in an open state.

FIG. 15 is a front view illustration of a foldable ornamental device, facilitating to user to change the peripheral shape of the ornamental article, according to another embodiment of the present invention, the article being in an open state.

### DETAILED DESCRIPTION OF THE INVENTION

Before explaining embodiments of the invention in detail, it is to be understood that the invention is not limited in its application to the details of construction and the arrangement of the components set forth in the host description or illustrated in the drawings.

An embodiment is an example or implementation of the inventions. The various appearances of “one embodiment”, “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

Meanings of technical and scientific terms used herein are to be commonly understood as to which the invention belongs, unless otherwise defined. The present invention can be implemented in the testing or practice with methods and materials equivalent or similar to those described herein.

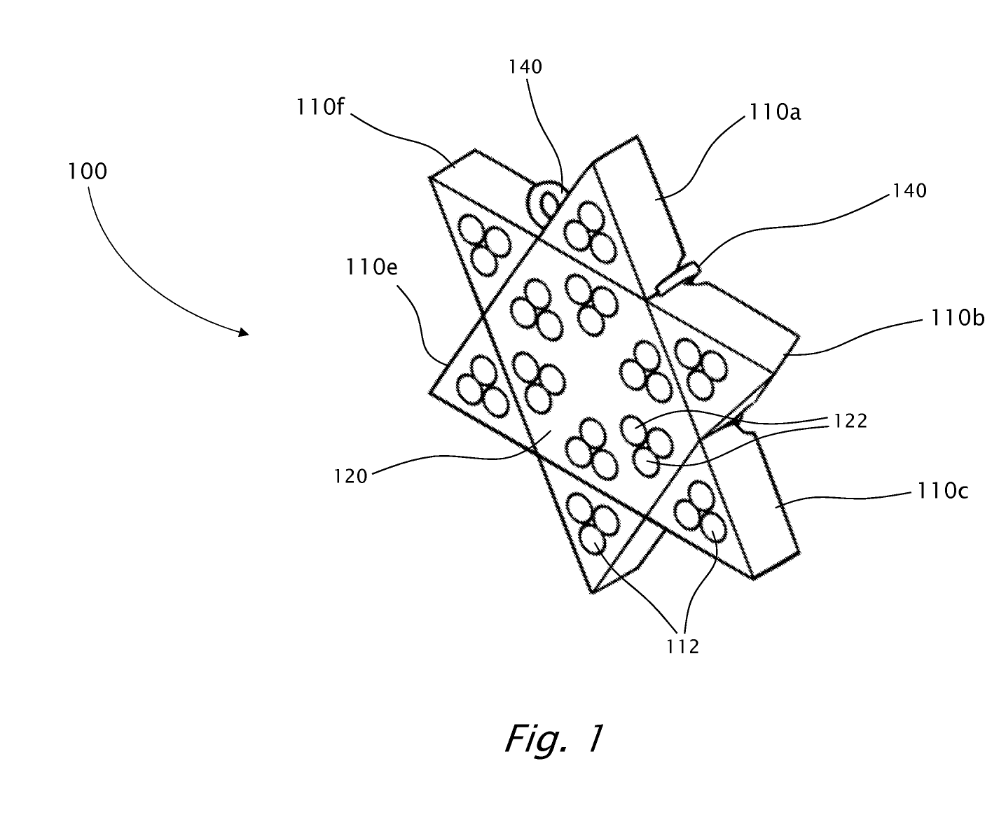

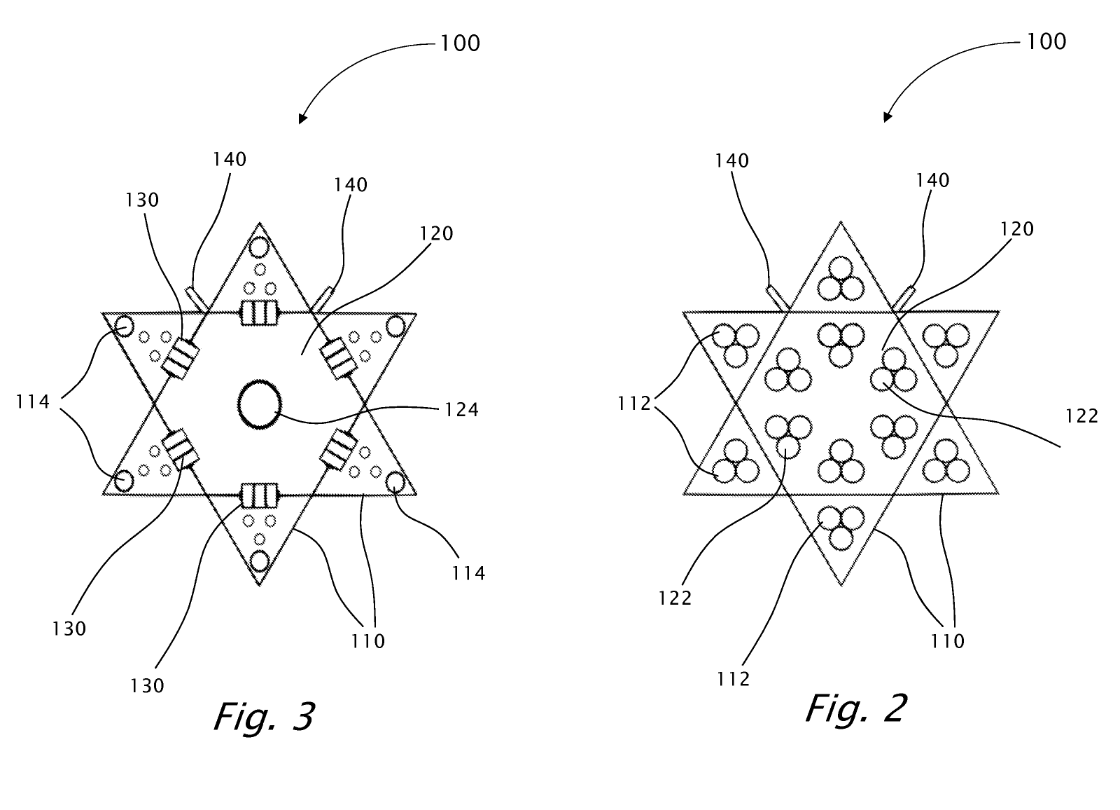

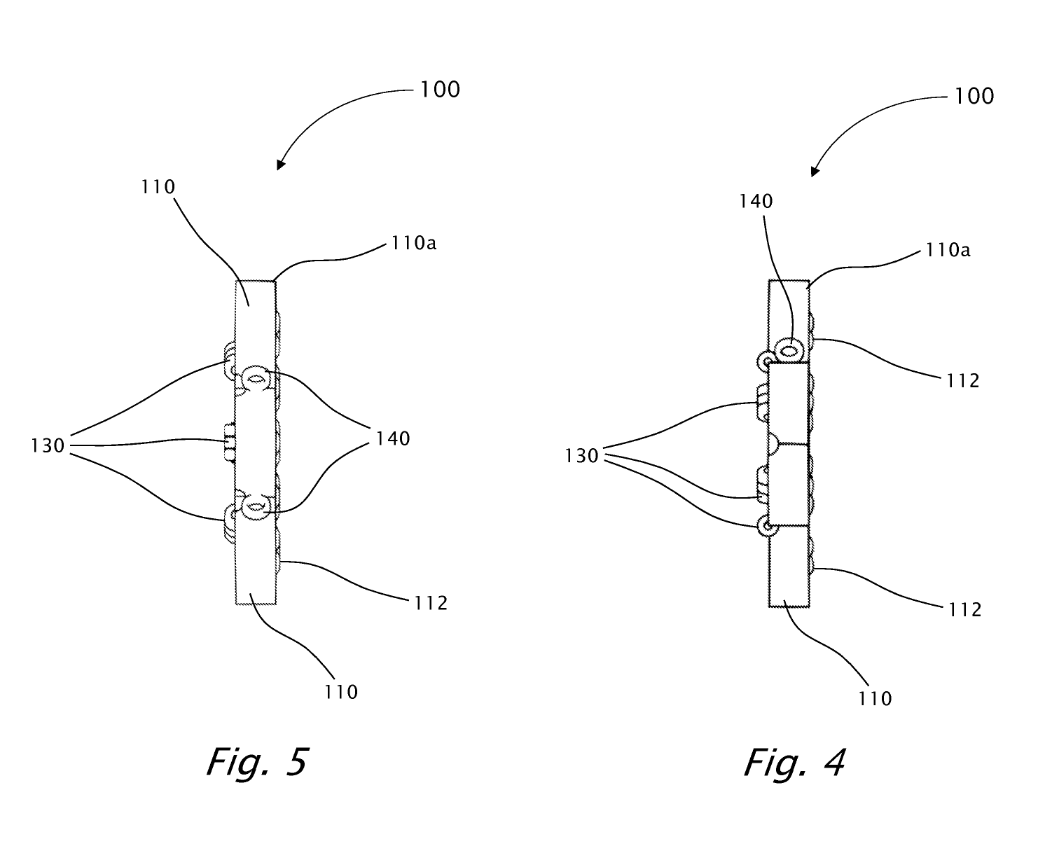

Reference is made to the drawings. FIG. 1 is a front-perspective view illustration of a foldable ornamental device 100, facilitating a user to change the peripheral shape of ornamental article 100, according to embodiments of the present invention, article 100 being in an open state. Reference is also made to FIG. 2, a front view illustration of foldable ornamental device 100; to FIG. 3, a rear view illustration of foldable ornamental device 100; to FIG. 4, a side view illustration of the foldable ornamental device 100; and to FIG. 5, a top view illustration of the foldable ornamental device 100.

Ornamental device 100 includes folding-elements 110, a main body 120 and a folding mechanism, such as a hinge 130. When in an open state, as shown in FIGS. 1-5, folding mechanism 130 facilitates pivotal motion of folding-elements 110 with respect to a main body 120, thereby changing the peripheral shape of ornamental article 100, as viewed from a distance.

As shown by way of example in FIGS. 1-5, ornamental article 100 is in open state, the peripheral shape of ornamental article 100 is that of a Star of David. In this example, main body 120 has a regular hexagon shape, typically, with no limitations, having side of substantially equal length. Six triangular folding-elements 110 are respectively disposed adjacent to each of the six sides of main body 120.

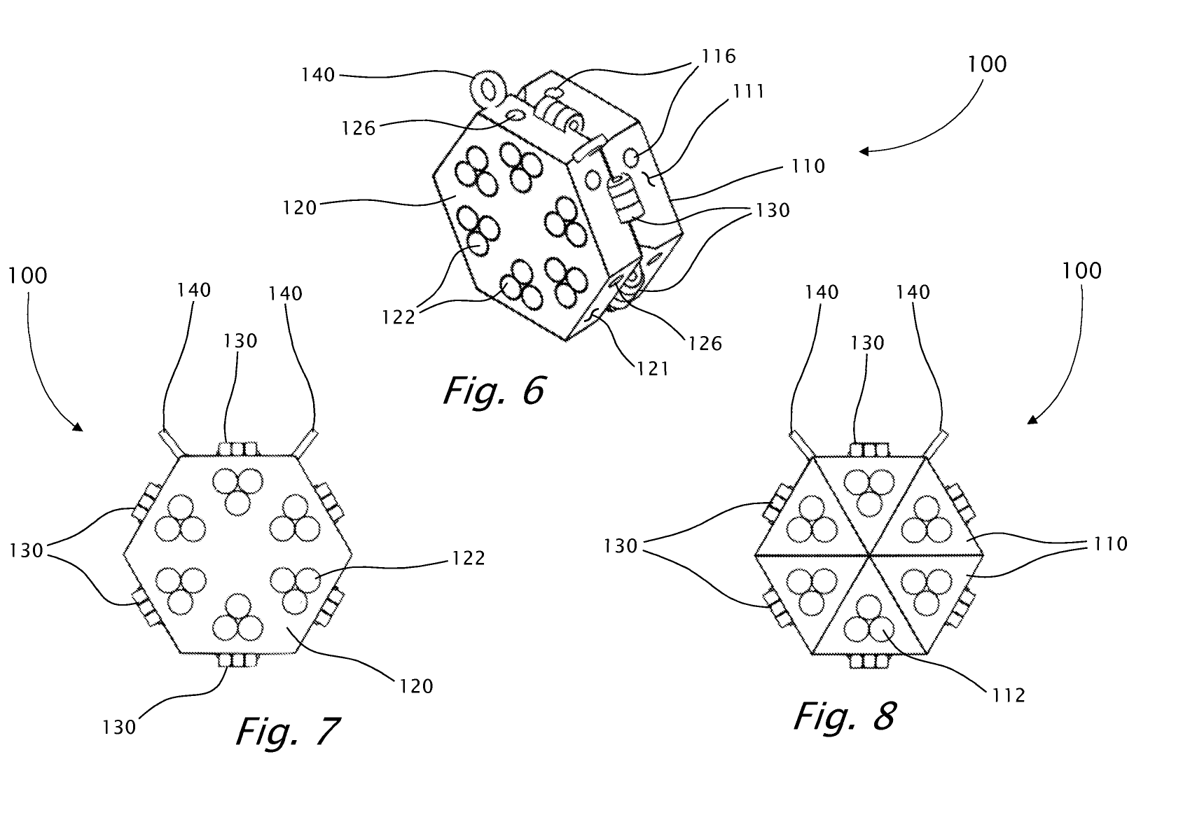

Reference is also made to FIG. 6, a perspective view illustration of foldable ornamental device 100, article 100 being in a folded state; to FIG. 7, a front view illustration of foldable ornamental device 100; and to FIG. 8, a rear view illustration of the foldable ornamental device 100. In this Star of David example, the six triangular folding-elements 110 were pivoted about respectively the respective side 121 of main body 120, using the respective hinge 130. In this example, the Star of David shaped ornamental device 100, has now become a hexagonal shaped ornamental device 100.

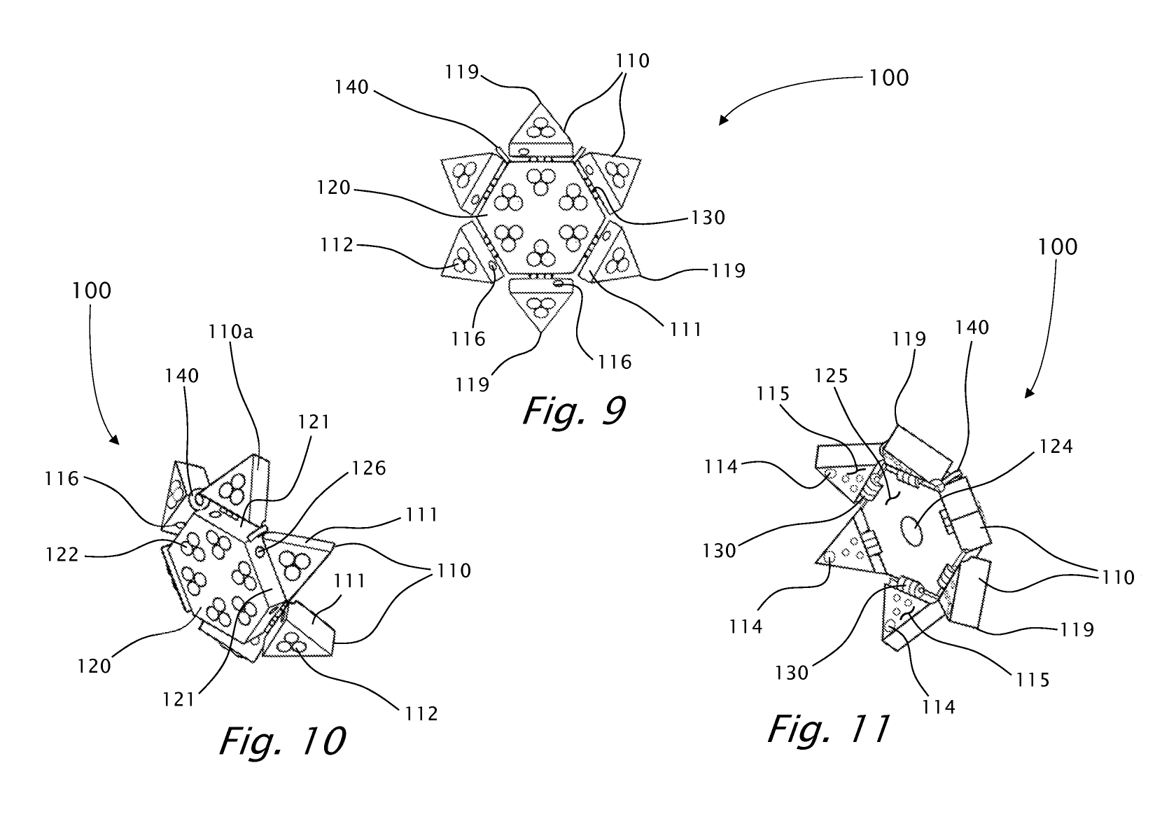

Reference is also made to FIG. 9, a front view illustration of foldable ornamental device 100, article 100 being in an intermediate state, between the open state, as shown in FIG. 2, and the folded state, as shown in FIG. 7; to FIG. 10, a front-perspective view illustration of foldable ornamental device 100; and to FIG. 11, a rear-perspective view illustration of the foldable ornamental device 100. In this Star of David example, the six triangular folding-elements 110 were partly pivoted about respectively the respective side 121 of main body 120, using the respective hinge 130.

It should be clarified that the user may fold, back and forth, and of the triangular folding-element 110, with respect to main body 120.

Preferably, ornamental device 100 further includes holding mechanisms, such as magnetic elements, to maintain each triangular folding-element 110 in in either an open state position or a closed state position. In this Star of David example shown in FIGS. 1-11, each pivoting-side 111 of triangular folding-elements 110 includes a magnetic element 116 disposed at a preconfigured position; and each side 121 of main body 120 includes a magnetic element 126 disposed at a preconfigured position. Furthermore, the rear-body-face 125 of main body 120 includes at least one magnetic element 124 and the rear faces of each of the triangular folding-elements 110 includes at least one magnetic element 114, in this example proximal to a tip 119 of the respective triangular folding-elements 110, which tip is 119 is the most distal from the respective hinge 130.

When in an open state, each pivoting-side 111 of triangular folding-elements 110 is disposed adjacently to the respectively side 121 of main body 120, and also, each magnetic element 116 of triangular folding-elements 110 is disposed adjacently to the respectively magnetic element 126, having an opposite polarity with respect to the polarity of magnetic element 116, such that the respective attracting magnetic force keep each pivoting-side 111 of triangular folding-elements 110 is held in position adjacently to the respectively side 121 of main body 120.

When in a folded state, the rear-triangle-face 115 of each triangular folding-element 110 is disposed adjacently to rear-body-face 125 of main body 120. Furthermore, each pivoting-side 111 of triangular folding-element 110 is disposed proximal to the respectively side 121 of main body 120, and also, tip 119 of each magnetic element 116 of triangular folding-elements 110 is disposed proximal to magnetic element 124, having an opposite polarity with respect to the polarity of magnetic element 114 such that the respective attracting magnetic force keep each triangular folding-element 110 in folded position.

Hinge 130 is pivotally connecting on the edges formed by the rear-body-face 125 of main body 120 and the respective edges, formed by the rear-triangle-face 115 of each triangular folding-element 110 and the respective pivoting-side 111 of that triangular folding-element 110. It should be noted that when ornamental device 100 is not in the folded state, there is no contact between the rear-body-face 125 of main body 120 and either of the rear-triangle-faces 115.

It should be noted the folding-elements 110 shown in the examples have a triangular shape. However, the present invention does not limited folding-elements 110 to be triangular and any other shape is within the scope of this invention. For example, if tip 119 is not a pointed tip but rather a rounded tip, the ornamental article has a flower-like shape, when in the open state.

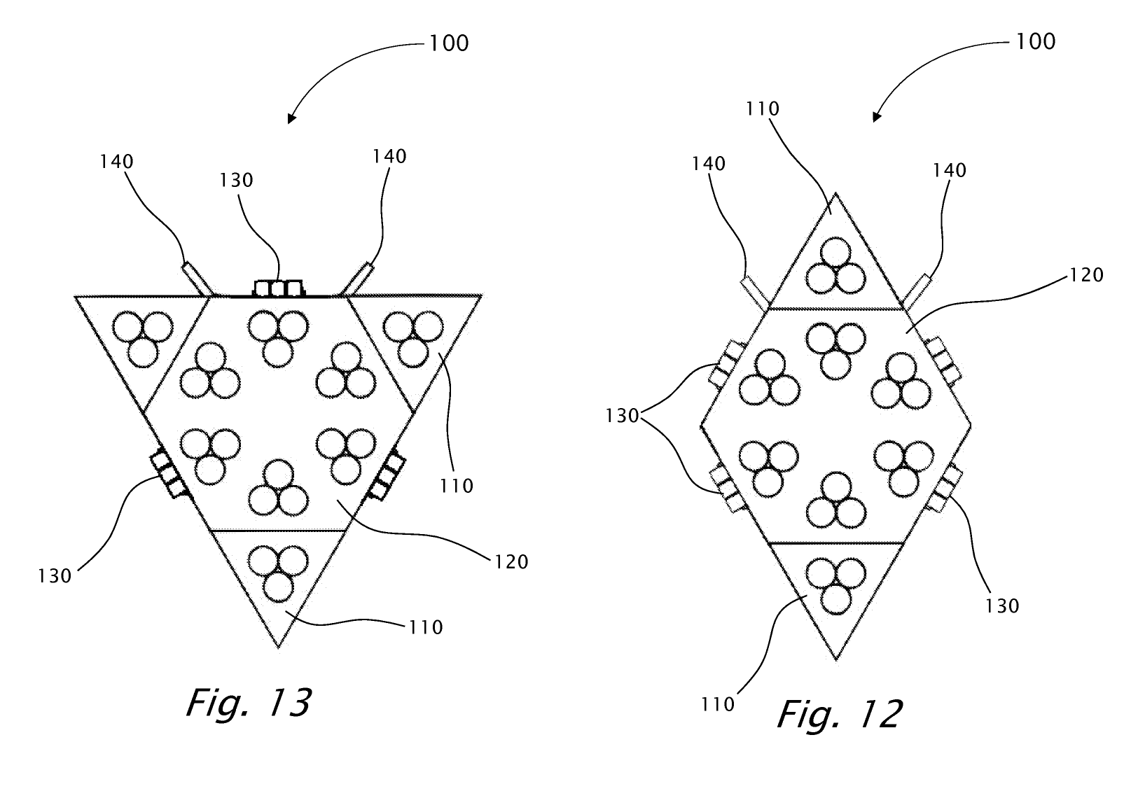

A user to change the peripheral shape of ornamental article 100, to thereby easily change the design of ornamental article 100, of as the user wishes, by flipping one or more selected triangular folding-elements 110. Reference is made to FIGS. 12 and 13, exemplifying different designs of ornamental article 100, wherein not all folding-elements 110 are folded, ornamental article 100 being in a semi-open state. FIG. 12 is a front view illustration of the foldable ornamental device shown in FIG. 1, exemplify a rhombus design; and FIG. 13 is a front view illustration of the foldable ornamental device shown in FIG. 1, exemplify a triangle design.

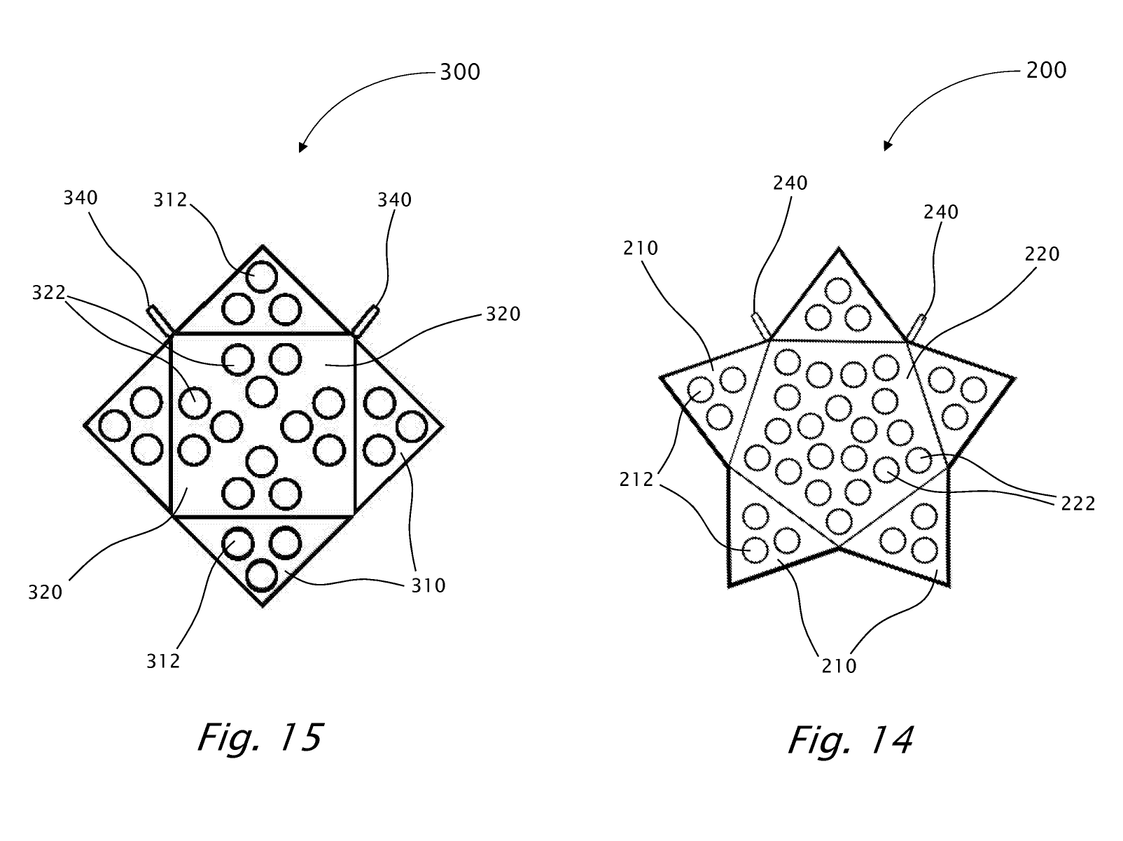

Reference is now made to FIG. 14, a front view illustration of a foldable ornamental device 200, facilitating to user to change the peripheral shape of ornamental article 200, according to an embodiment of the present invention, article 200 being in an open state. In this example, foldable ornamental device 200 operates similarly to device ornamental device 100, except that the main body 220 is regular pentagonal shaped rather than of hexagonal shape, and there are five triangular folding-elements 110 rather than six.

FIG. 15 is a front view illustration of a foldable ornamental device 300, facilitating to user to change the peripheral shape of ornamental article 300, according to another embodiment of the present invention, article 300 being in an open state. In this example, foldable ornamental device 300 operates similarly to device ornamental device 100, except that the main body 320 is square rather than of hexagonal shape, and there are four triangular folding-elements 310 rather than six.

It should be noted that in the figures, the ornamental articles (100, 200, 300) include optional hanging element (140, 240, 340), facilitating hanging the ornamental articles (100, 200, 300) on a chain.

It should be further noted that in the figures, the ornamental articles (100, 200, 300) are shown with gemstones (112, 122, 212, 222, 312, 322) embedded therein, which gemstones are shown by way of example only, and which gemstones may be embedded in any other design or not embedded at all.

The present invention being thus described in terms of several embodiments and examples, it will be appreciated that the same may be varied in many ways. Such variations are not to be regarded as a departure from the spirit and scope of the invention, and all such modifications as would be obvious to one skilled in the art are contemplated.

1. An ornamental article, facilitating a user to change the peripheral shape of the ornamental article, the ornamental article comprising:
a) a main body, having a front face and a rear-body-face and a number of sides;
b) at least one folding-element, having a front face, a rear-triangle-face, a pivoting-side and a tip disposed oppositely to said pivoting-side;
c) a folding mechanism; and
d) holding mechanisms for maintaining each one of said triangular folding-elements in either an open state position or a closed state position,
wherein said folding mechanism facilitates the user to pivot said at least one folding-element with respect to said main body and thereby, change the peripheral shape of the ornamental article, as viewed from a distance;
wherein when all of said folding-elements are unfolded, the ornamental article is in an open state; when all of said folding-elements are folded, the ornamental article is in a closed state; and when a portion of said folding-elements are folded, the ornamental article is in a semi-open state;
wherein when said at least one folding-element is in a closed state said rear-triangle-face is disposed adjacently to said rear-body-face; and
wherein said holding mechanism is a pair of magnets having opposing polarity, such that the magnetic force attracts said magnets to each other to thereby prevent said at least one folding-element from folding away from either said open state or said closed state.

2. The ornamental article of claim 1, wherein each of said sides of said main body, having a respective one of folding-elements pivotally attached thereto, and said pivoting-side of said respective folding-element, have one of said pair of magnets embedded therein, forming one of said holding mechanisms, wherein when said folding-element is in said open state, said folding-element is held adjacent to said respective side of said main body.

3. The ornamental article of claim 1, wherein one of said pair of magnets is embedded at a preconfigured location at said rear face of said main body, and a second of said pair of magnets is embedded at said tip of each of said folding-elements, wherein when said folding- element is in said closed state, said tip is held adjacent to said magnet embedded in said rear face of said main body.

4. The ornamental article of claim 3, wherein two or more of said magnets embedded at said preconfigured location at said rear face of said main body, up to the number of said folding-elements, are combined to form a single magnet.

5. The ornamental article of claim 1, wherein said main body has a regular hexagon shape and said folding-elements are six fitted triangular elements, pivotally attached to each of said six sides of said main body.

6. The ornamental article of claim 1, wherein said main body has a regular pentagonal shape and said folding-elements are five fitted triangular elements, pivotally attached to each of said five sides of said main body.

7. The ornamental article of claim 1, wherein said main body has a regular square shape and said folding-elements are four fitted triangular elements, pivotally attached to each of said four sides of said main body.

8. The ornamental article of claim 7, wherein said tips of said folding-elements are rounded.

9. The ornamental article of claim 5, wherein said tips of said folding-elements are rounded.

10. The ornamental article of claim 6, wherein said tips of said folding-elements are rounded.
